(19) United States
(12) Patent Application Publication
(10) Pub. No.: US 2026/0070396 A1
(43) Pub. Date: Mar. 12, 2026

(54) ACTUATOR ASSEMBLY FOR A VEHICLE AIR REGISTER

(71) Applicant: Ford Global Technologies, LLC, Dearborn, MI (US)

(72) Inventors: Alba Elena Vázquez Hernández, Chimalhuacan (MX); José Gerardo Velasco Macías, Mexico City (MX); Benjamin John Keur, Northville, MI (US); George David Koch Smith, Lake Orion, MI (US); Pablo Hugo Valencia Chaparro, Mexico City (MX)

(73) Assignee: Ford Global Technologies, LLC, Dearborn, MI (US)

(21) Appl. No.: 18/829,860

(22) Filed: Sep. 10, 2024

(51) Int. Cl. B60H 1/34

(52) U.S. Cl. CPC B60H 1/3421; B60H 2001/3471

(57) ABSTRACT

An air delivery system for a vehicle including at least one air register assembly. The air register assembly includes a housing defining a first portion and a second portion. The first portion of the housing includes a bottom wall, and first and second sidewalls. A linked vane assembly is disposed in a cavity defined by the first portion of the housing and a pivoting vane assembly is disposed in a cavity defined by the second portion of the housing. A first actuator is operably coupled with the linked vane assembly and is coupled with the first sidewall. A second actuator is operably coupled with the pivoting vane assembly and is coupled with the bottom wall. The first and second actuators include a body and locating flanges extending from the body to receive fasteners for coupling the respective actuator to the housing.

### FIELD OF THE DISCLOSURE

The present disclosure generally relates to an actuator assembly. More specifically, the present disclosure relates to an actuator assembly of an air register for a vehicle.

### BACKGROUND OF THE DISCLOSURE

Vehicles may have a heating, ventilation, and air conditioning system to provide conditioned air to a passenger cabin. The direction of the air may be adjusted by the passenger.

### SUMMARY OF THE DISCLOSURE

According to a first aspect of the present disclosure, an air delivery system for a vehicle includes at least one air register assembly. The at least one air register assembly includes a housing defining a first portion and a second portion, where the housing includes a top wall, a bottom wall, and first and second sidewalls. A linked vane assembly is disposed in a cavity defined by the first portion of the housing, and a pivoting vane assembly is disposed in a cavity defined by the second portion of the housing. A first actuator is operably coupled with the linked vane assembly to direct movement of the linked vane assembly, where the first actuator is coupled with the first sidewall. A second actuator is operably coupled with the pivoting vane assembly to direct movement of the pivoting vane assembly, where the second actuator is coupled with the bottom wall. Each of the first and second actuators includes a body including a first side and a second side, where the body defines a coupling joint in the first side and the second side. Coupling flanges extend from the body to receive fasteners for coupling the respective actuator to the housing.

The first aspect of the present disclosure can include any one or a combination of the following features:
each flange defines an aperture for coupling the first and second actuators to the housing via the fasteners, where the coupling flanges extend in different directions from the body of each of the first actuator and the second actuator;
at least one air register assembly includes a plurality of projections extending from each of the first sidewall and the bottom wall of the housing, where at least one of the plurality of projections on each of the first sidewall and the bottom wall includes locating ribs;
at least one of the coupling flanges of the first actuator is disposed between the locating ribs on the first sidewall, where at least one of the coupling flanges of the second actuator is disposed between the locating ribs on the bottom wall;
the body of each of the first and second actuators includes a locating flange, where the housing includes a locating pin extending from each of the first sidewall and the bottom wall;
each of the locating flanges defines an aperture, where the locating flange of the first actuator is configured to receive the locating pin extending from the first sidewall and the locating flange of the second actuator is configured to receive the locating pin extending from the bottom wall of the housing;
the air delivery system further includes third and fourth actuators, where the at least one air register assembly includes a first air register and a second air register, and where the first and second actuators are coupled with the first air register, and further wherein the third actuator is coupled to the second sidewall of the housing of the second air register and the fourth actuator is coupled to the bottom wall of the housing of the second air register;
the first side of the first and second actuators engage the housing of the first air register to allow the coupling joints on the first sides of the first and second actuators to engage the linked vane assembly and the pivoting vane assembly, respectively, of the first air register, where the second side of the third and fourth actuators engage the housing of the second air register to allow the coupling joints on the second sides of the third and fourth actuators to engage the linked vane assembly and the pivoting vane assembly, respectively, of the second air register;
a link feature includes an engagement pin extending through a slot defined by the first sidewall, where the link feature is coupled with the linked vane assembly, a drive link is operably coupled to the coupling joint of the first side of the first actuator and the link feature to adjust a position of the linked vane assembly, and a drive peg operably coupled to the coupling joint of the second actuator and the pivoting vane assembly to adjust a position of the pivoting vane assembly; and
the bottom wall of the housing defines an opening, where the drive peg extends through the opening to engage the coupling joint of the second actuator.

According to a second aspect of the present disclosure, an air register assembly for a vehicle includes an air register including a housing having a top wall, a bottom wall, and first and second sidewalls to at least partially define a cavity. Coupling projections extend from the housings, where at least one of the projections defines locating ribs. Locating pins extend from the housing proximate to the coupling projections. A first vane assembly having first vanes disposed in the cavity and a second vane assembly having second vanes disposed in the cavity, where the second vane assembly is positioned proximate the first vane assembly. A first actuator is operably coupled to the first sidewall of the air register via the coupling projections and locating pins and at least one of the locating pins. The first actuator engages the first vane assembly to direct movement of the first vanes in a first direction. A second actuator is operably coupled to the bottom wall of the air register via the coupling projections and at least one of the locating pins, where the second actuator engages the second vane assembly to direct movement of the second vanes in a second direction.

The second aspect of the present disclosure can include any one or a combination of the following features:
each of the first actuator and the second actuator includes a body positioned within a space defined by a respective set of the coupling projections, where the body of the first and second actuators includes a first side and a second side, the first side opposite the second side;
each of the first actuator and the second actuator includes a coupling joint having a first joint extending partially through a first portion of the body from the first side and a second joint extending partially through a second portion of the body from the second side;
the coupling projections and the locating pins each extend from the first sidewall and the bottom wall of the housing, where the first side of the first actuator is disposed adjacent to the first sidewall and the first joint is operably engaged with the first vanes of the first vane assembly, and where the first side of the second actuator is disposed adjacent to the bottom wall and the second joint is operably engaged with the second vanes of the second vane assembly;
the coupling projections and the locating pins each extend from the second sidewall and the bottom wall of the housing, where the second side of the first actuator is disposed adjacent to the second sidewall and the second joint is operably engaged with the first vanes of the first vane assembly, and where the second side of the second actuator is disposed adjacent to the bottom wall and the second joint engages the second vanes of the second vane assembly; and
a secondary air register including a housing having a first sidewall, a second sidewall, and a bottom wall at least partially defining a cavity, a third actuator is operably coupled to the second sidewall of the housing of the second air register, and a fourth actuator is operably coupled to the bottom wall of the housing of the second air register.

According to a third aspect of the present disclosure, an air register assembly for a vehicle includes a housing including a bottom wall and opposing sidewalls to at least partially define a cavity. A fastening feature extending from at least one of the opposing sidewalls of the housing. A vane assembly is disposed in the cavity of the housing, where the vane assembly includes first vanes and second vanes configured to direct air to an interior of said vehicle. Actuators are operably coupled to the housing, where the actuators are configured to adjust the first vanes and the second vanes, respectively, and where the actuators each include a coupling joint. A drive link is operably coupled to the fastening feature and the coupling joint of one of the actuators. A link feature is disposed within the cavity and includes an engagement pin extending through a slot on the housing. The link feature is coupled to the drive link and the vane assembly, where one of the actuators rotates the drive link to move the link feature in a predetermined path along the slot to adjust the position of the first vanes.

The third aspect of the present disclosure can include any one or a combination of the following features:
the air register assembly includes an opening defined on the bottom wall of the housing, and a drive peg disposed partially within the opening of the housing, where the drive peg is coupled to the second vanes of the vane assembly;
the drive peg engages the coupling joint of a second one of the actuators to rotate the drive peg and adjust the position of the second vanes; and
each of the actuators includes a first side and a second side, where the coupling joint is defined on each of the first side and the second side such that each of the first side and the second side of each of the actuators are configured to engage the vane assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a vehicle dashboard with an air delivery system, according to the present disclosure;

FIG. 2 is a partial side perspective view of an air delivery system having air registers aligned with a bezel, according to the present disclosure;

FIG. 3 is a side perspective view of an air register including actuators coupled to a sidewall and a bottom wall of the air register, according to the present disclosure;

FIG. 4 is a partial side perspective view of projections, locating ribs, and a locating pin disposed extending from a first sidewall of a housing of an air register, according to the present disclosure;

FIG. 5 is a side perspective view of a first air register and a second air register of an air delivery system having actuators, according to the present disclosure;

FIG. 6 is a front plan view of an actuator including coupling flanges and a locating flange, according to the present disclosure;

FIG. 7 is a partial side perspective view of an actuator coupled to a bottom wall of an air register, according to the present disclosure;

FIG. 8 is a cross-sectional side elevational view of the actuator engaging a sidewall of a housing of FIG. 3, taken along line VII-VII, according to the present disclosure;

FIG. 9 is a cross-sectional top plan view of the air register of FIG. 2, taken along line X-X, according to the present disclosure;

FIG. 10 is a cross-sectional side elevational view of the air register of FIG. 2, taken along line XI-XI, according to the present disclosure;

FIG. 11 is a side perspective view of a linked vane removed from an air register, according to the present disclosure;

FIG. 12 is a partially exploded view of an air register having two actuators, according to the present disclosure; and

FIG. 13 is a block diagram of an air delivery system for a vehicle, according to the present disclosure.

### DETAILED DESCRIPTION

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

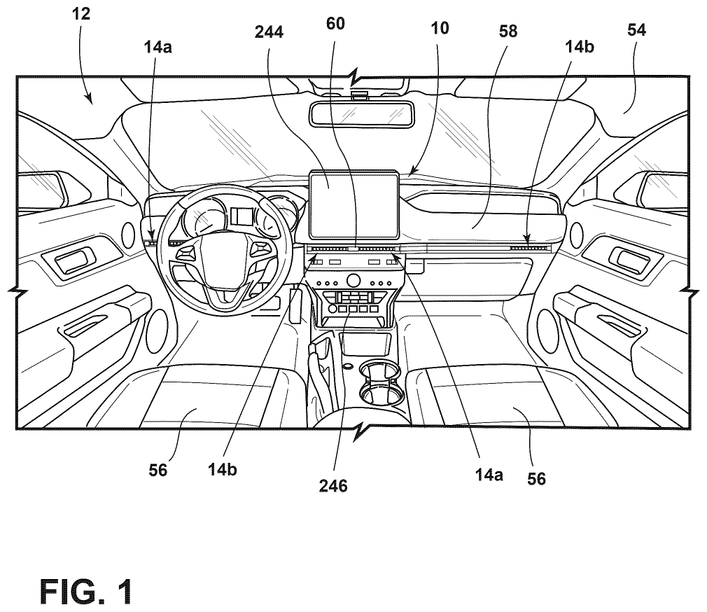

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an actuator assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about. ” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-13, reference numeral 10 generally designates an air delivery system for a vehicle 12 that includes at least one air register 14, which generally includes a first air register 14a and a second air register 14b that can collectively be referred to herein as the air registers 14. The air registers 14 each include a housing 16 defining an upstream housing portion 18 and a downstream housing portion 20. The housing 16 includes a top wall 22, a bottom wall 24, and first and second sidewalls 26a, 26b. A linked vane assembly 28 is disposed in a first cavity portion 30 defined by the downstream housing portion 20 of the housing 16. A pivoting vane assembly 32 is disposed in a second cavity portion 34 defined by the upstream housing portion 18.

The air registers 14 also include multiple actuators 36, which generally include actuators 36a-36d, which may be collectively referred to herein as the actuators 36. Actuators 36a, 36c are operably coupled with the linked vane assemblies 28 to direct movement of the linked vane assemblies 28. Actuators 36b, 36d are operably coupled with the pivoting vane assemblies 32 to direct movement of the pivoting vane assemblies 32. Further, the actuators 36a, 36b are generally coupled with the first air register 14a, while the actuators 36c, 36d are generally coupled with the second air register 14b. Each of the actuators 36 includes a body 38 defining a coupling joint 40 extending inward from first and second sides 42a, 42b, respectively. The actuators 36 also include flanges 44a-44d, also referred to as coupling flanges 44a-44d, extending from the body 38 to receive fasteners 46 for coupling the actuators 36 to the housing 16.

Referring to FIG. 1, the vehicle 12 includes an interior compartment 54, which includes seating assemblies 56 for supporting passengers thereon. An instrument panel or dashboard 58 extends in a cross-car direction in a vehicle-forward portion of the interior compartment 54 proximate to the seating assemblies 56. A bezel 60 is coupled to the dashboard 58 and extends in the cross-car direction. The bezel 60 may extend entirely from one side of the vehicle 12 to the other or alternatively may extend a portion of the distance between opposing lateral sides of vehicle 12.

The vehicle 12 may be a sedan, a sport utility vehicle, a van, a truck, a crossover, other styles of wheeled motor vehicles, or other styles of vehicles. The vehicle 12 may be a manually operated vehicle (e.g., operated with a human driver), a fully autonomous vehicle (e.g., operated without a human driver), or a partially autonomous vehicle (e.g., operated with or without a human driver). Additionally, the vehicle 12 may be utilized for personal and/or commercial purposes, such as for ride-providing services (e.g., chauffeuring), transporting, and/or ride-sharing services.

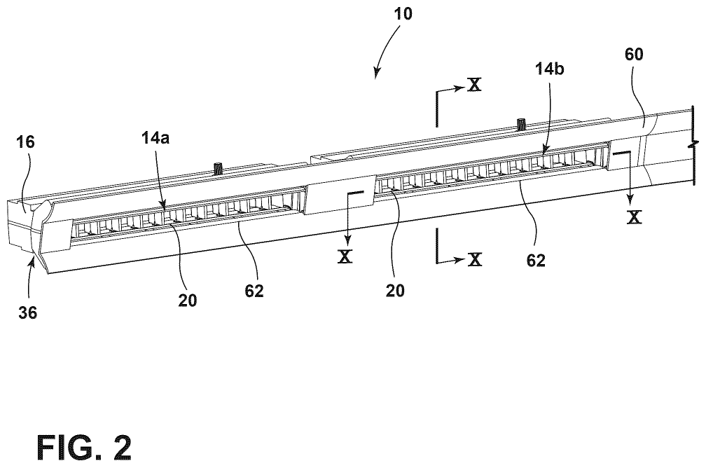

Referring still to FIG. 1, as well as FIG. 2, the bezel 60 defines multiple airflow openings 62 that align with outlets 64 of the air registers 14. The airflow openings 62 fluidly couple the interior compartment 54 with a heating, ventilation, and air conditioning (HVAC) system for the vehicle 12. The air registers 14 direct air from the HVAC system into the interior compartment 54. The HVAC system generally cleans, cools, heats, regulates, ventilates, and/or dehumidifies air directed into the interior compartment 54. The air registers 14 engage ducting that extends to the HVAC system. A passenger or user within the vehicle 12 may utilize the air registers 14 to direct the air traveling through the air registers 14 to certain locations or in certain directions to increase the comfort of the passenger.

In general, multiple air registers 14 are engaged with the dashboard 58, including the air registers 14a, 14b, which may form a pair of air registers that are mirror images of one another. In certain aspects, there are four air registers 14 arranged on the dashboard 58 with two pairs (i.e., left and right pairs) of air registers 14a, 14b. In such examples, the vehicle 12 may include a lefthand outboard register 14a, a lefthand inboard register 14b, a righthand inboard register 14a, and a righthand outboard register 14b.

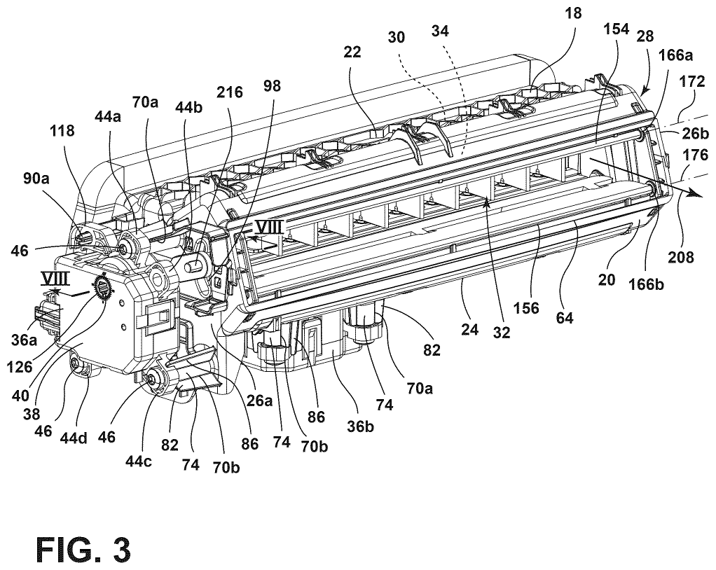

Referring still to FIG. 2, as well as FIG. 3, each air register 14 includes the housing 16. The housings 16 of the air registers 14 include the upstream housing portion 18 which defines the first cavity portion 30 and the downstream housing portion 20 which defines the second cavity portion 34. The downstream housing portion 20 includes the top wall 22, the bottom wall 24, and the first and second sidewalls 26a, 26b to at least partially define the second cavity portion 34. The configuration of the upstream housing portion 18 is generally different from the configuration of the downstream housing portion 20. For example, the configuration of the upstream housing portion 18 accommodates movement of the pivoting vane assembly 32, while the configuration of the downstream housing portion 20 accommodates movement of the linked vane assembly 28. The upstream housing portion 18 defines an inlet 66 that is generally coupled with the ducting and fluidly couples the air registers 14 with the HVAC system of the vehicle 12. The downstream housing portion 20 defines the outlet 64 which aligns with the respective airflow opening 62 defined by the bezel 60. Accordingly, the air registers 14 may be included in the vehicle 12 and aligned with the airflow openings 62 in the bezel 60.

In various examples, the air registers 14 are high aspect ratio air registers. In such configurations, the outlets 64 are narrow and elongated, each having a width that is at least about 150 mm and a height that is less than about 25 mm. Additionally, the airflow openings 62 defined by the bezel 60 may be narrow, elongated openings that blend with the aesthetics of the dashboard 58. The outlets 64 and the corresponding airflow openings 62 are each generally narrow and elongated.

Additionally, the housings 16 of the air registers 14 may include multiple portions coupled together. For example, the housings 16 may include a first portion defining a top half of the housing 16 and a second portion defining a bottom half of the housing 16. The first portion and the second portion of the housing 16 may be coupled to one another to form the housing 16 and collectively define the cavity potions 30, 34.

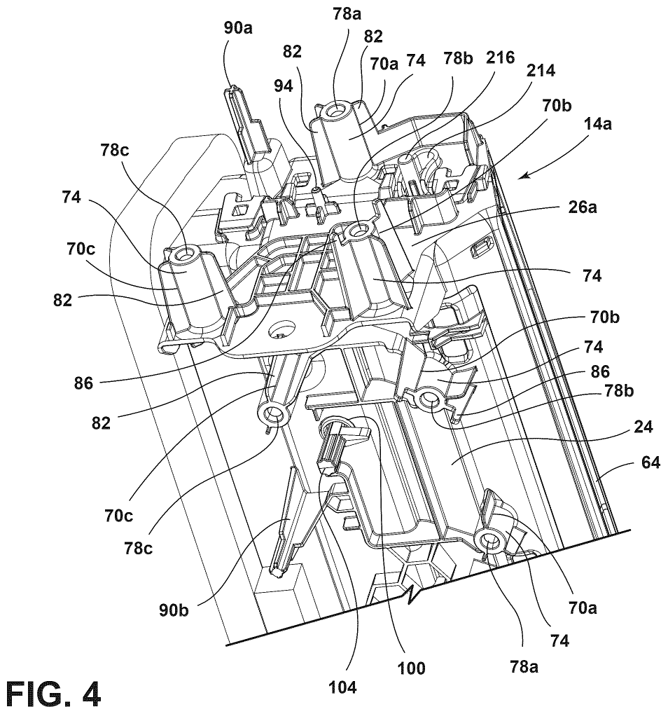

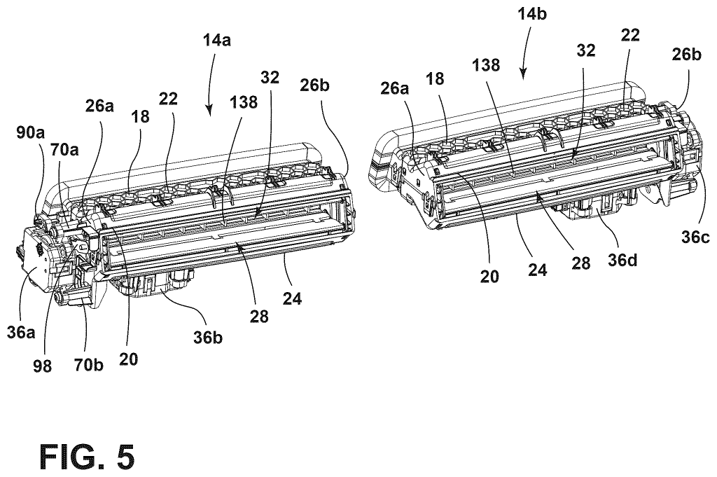

Referring to FIG. 3, as well as FIGS. 4 and 5, the housing 16 of the air registers 14 includes the first and second sidewalls 26a, 26b and the bottom wall 24. The housings 16 of the air registers 14 may include coupling or receiving projections 70, which generally include projections 70a-70c, which may be collectively referred to herein as projections 70. The projections 70 assist in aligning and securing the actuators 36 to the housing 16 of the air registers 14. For the first air register 14a, the projections 70 extend from the first sidewall 26a and the bottom wall 24, and for the second air register 14b, the projections 70 extend from the second sidewall 26b and the bottom wall 24. In this regard, the housings 16 for the pair of air registers 14a, 14b are mirror images of one another. As illustrated, the projections 70 may extend from the outer sidewalls 26a, 26b, respectively, but may extend from the inner sidewalls 26a, 26b (e.g., the second sidewall 26b for the first air register 14a and the first sidewall 26a for the second air register 26b) without departing from the teaching herein.

The projections 70 each include a base 74 that defines a respective aperture 78a-78c configured to receive the fasteners 46 when the actuators 36 are aligned on/with the projections 70. The base 74 of the projections 70 includes radially extending support ribs 82 that extend from the base 74 to assist in stabilizing the actuators 36 that are coupled to the housing 16, as well as for providing additional structural support. As illustrated, the projections 70 may include at least one support rib 82 or up to three support ribs 82, however, it is contemplated that the projections 70 may not include the support ribs 82 or may include more than three support ribs 82.

Each of the projections 70 extends from the respective one of the first sidewall 26a or the second sidewall 26b, as well as the bottom walls 24 to assist in coupling the actuators 36 to the air registers 14, as is further described herein. For example, the projections 70 may generally extend between the first sidewall 26a and one of the lateral sides of the vehicle 12 or may generally extend between the second sidewall 26b of the housing 16 of the air registers 14 and the opposing lateral sides of the vehicle 12. In another example, the projections 70 may generally extend from the bottom wall 24 of the housing 16 in a downward direction when the air registers 14 are assembled in the vehicle 12. Additionally, as illustrated, the housing 16 includes three projections 70 in each set or group of projections 70, however, it is contemplated that the housing 16 may include more or less than three projections 70 on any one of the first sidewall 26a, second sidewall 26b, and/or bottom wall 24 of the housings 16 of the air registers 14.

At least one of the projections 70 in each group or set defines locating ribs 86 that extend outwardly or farther from the base 74 proximate the support ribs 82. The locating ribs 86 may extend in opposing directions from each other, and with at least one support rib 82 to form a generally T-shape configuration on the base 74 of the projections 70. In the illustrated configuration of FIG. 4, the projection 70b includes the locating ribs 86, and the locating ribs 86 may extend beyond an end of the projection 70b to assist in positioning and installing the actuators 36 on the housing 16 of the air registers 14. For example, the locating ribs 86 may form a 2-way locator feature, with at least two extended locating ribs 86 positioned on at least one of the projections 70. The 2-way locator feature of the locating ribs 86 allows for compatibility with various housing 16 configurations providing a secure fit of the actuators 36 and reducing movement in two opposing directions.

Referring still to FIGS. 3 and 4, the housings 16 can include a locating pin 90a on a respective one of the sidewalls 26a, 26b proximate the respective projections 70, and the bottom wall 24 of the housing 16 of the air registers 14 may include a locating pin 90b proximate to the respective projections 70. For example, as illustrated, the locating pins 90a, 90b are disposed proximate the respective projection 70a. The locating pins 90a, 90b may extend from one of the first sidewall 26a or second sidewall 26b and from the bottom wall 24 of the housings 16 of the air registers 14, respectively. The locating pins 90a, 90b may provide a reduction in movement or constraints in four directions to form a 4-way locator feature. Accordingly, the locating pins 90a, 90b may be narrower at a distal end and may become broader proximate to the housing 16. As such, the locating pins 90a, 90b provide an additional level of positioning accuracy and stability for the actuators 36. The locating pins 90a, 90b and the locating ribs 86 of the projection(s) 70a, 70b, 70c operate in conjunction with one another to provide for a multi-point reference system for placement of the actuators 36 on the housing 16 of the air registers 14, as is further described herein.

The first sidewall 26a of the first air register 14a and the second sidewall 26b of the second air register 14b may further include a guiding or fastening feature 94 positioned proximate at least one of the projections 70 and the locating pins 90a, 90b. In this regard, each housing 16 includes two sets of projections 70 and locating features (i.e., the locating ribs 86, the locating pins 90a, 90b) including one set on one of the sidewalls 26a, 26b and a second set on the bottom wall 24. Each set of projections 70 and locating features (i.e., the locating ribs 86, the locating pins 90a, 90b), as illustrated, includes the projections 70 with at least one projection 70b including the locating ribs 86 and the locating pins 90a, 90b.

As illustrated in FIG. 4, the fastening feature 94 is positioned proximate to projection 70b on the first sidewall 26a. The fastening feature 94 may not be included on the bottom walls 24. The fastening feature 94 may be configured to further assist in coupling the actuators 36a, 36c to the first and second sidewalls 26a, 26b of the housing 16 of the air registers 14. Additionally, the fastening feature 94 may engage a drive link 98 to assist in transferring motion from the respective actuator 36a, 36c via the drive link 98 to adjust the linked vane assembly 28.

Additionally, the bottom wall 24 of the housing 16 of the air registers 14 may include an opening 100 proximate the projections 70, which may be omitted from the sidewalls 26a, 26b. For example, as illustrated in FIG. 4, the opening 100 is defined proximate to projection 70a of the bottom wall 24 of the housing 16. The opening 100 may be configured to receive a drive peg 104 that can engage the actuators 36b, 36d to assist in adjusting the pivoting vane assembly 32.

Referring to FIGS. 3-5, each of the air registers 14 includes multiple coupling and alignment components (i.e., the locating ribs 86, the locating pins 90a, 90b, and the fastening feature 94) arranged in two locations to assist in coupling the actuators 36 to the housing 16 and for positioning the air registers 14 within the vehicle 12. For example, the first air register 14a, which is generally a left air register 14a positioned in the dashboard 58, has the projections 70 with the locating ribs 86, the locating pin 90a, and the fastening feature 94 extending from the first sidewall 26a of the housing 16. Additionally, the first air register 14a also includes the projections 70 including the locating ribs 86 and the locating pin 90b extending from the bottom wall 24 of the housing 16. The bottom wall 24 of the first air register 14a defines the opening 100.

In comparison, the second air register 14b, which is generally a right air register 14b, positioned in the dashboard 58 has the projections 70 with the locating ribs 86, the locating pin 90a, and the fastening feature 94 extending from the second sidewall 26b of the housing 16. Additionally, the second air register 14b includes the projections 70 with the locating ribs 86, the locating pin 90b extending from the bottom wall 24 of the housing 16 of the second air register 14b. The bottom wall 24 of the second air register 14b defines the opening 100. Accordingly, the first and second air registers 14a, 14b are generally mirror images of one another.

The air delivery system 10 includes the actuators 36 coupled to the sidewalls 26a, 26b and the bottom wall 24 of the housing 16 of the air registers 14a, 14b, respectively. The actuators 36 include actuator 36a, which is generally a left linked actuator 36a coupled to the first sidewall 26a of the first air register 14a, and actuator 36c, which is generally a right linked actuator 36c, coupled to the second sidewall 26b of the second air register 14b. Additionally, the actuators 36 include actuator 36b, which is generally a left pivot actuator 36b coupled to the bottom wall 24 of the first air register 14a, and actuator 44d, which is generally a right pivot actuator 36d coupled to the bottom wall 24 of the second air register 14b.

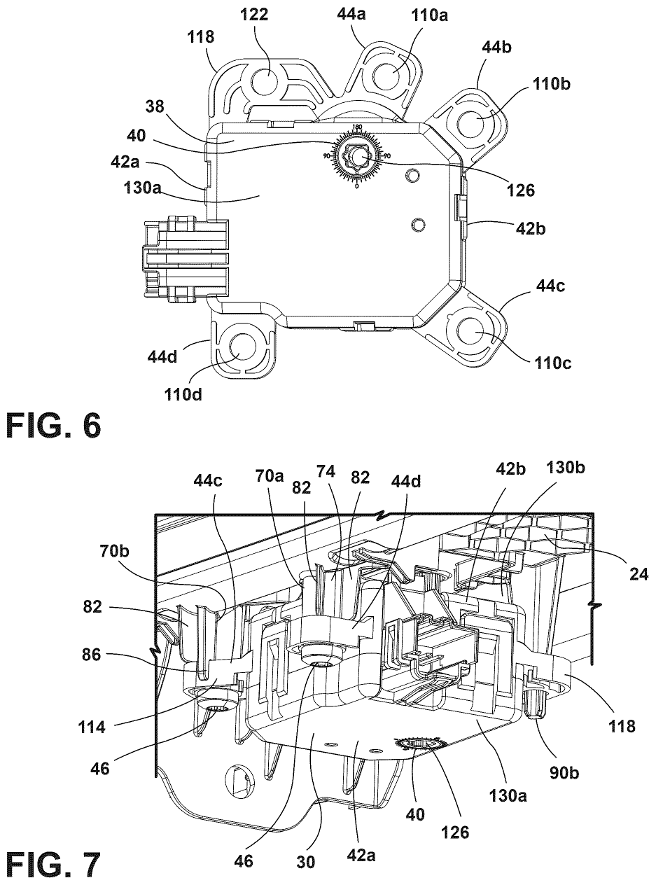

Referring still to FIG. 5, as well as FIGS. 6 and 7, each of the actuators 36 includes a substantially similar or the same configuration, resulting in modular actuators 36 that can be arranged in four locations over two different housing 16 structures (e.g., eight locations over the two pairs of air registers 14a, 14b). Each of the actuators 36 includes the body 38 with the flanges 44a-44d that extend from the body 38. The flanges 44a-44d extend in different directions from the body 38 and are positioned to provide mounting points and structural support for the actuators 36 when the actuators 36 are coupled to the housing 16 of the air registers 14. The outer edges of each of the flanges 44a-44d are chamfered or radiused to reduce sharp corners and minimize stress concentrations when the actuators 36 are in operation. Each of the flanges 44a-44d defines a respective aperture 110a-110d that may be positioned in a central location of the flanges 44a-44d to assist in coupling the actuators 36 to the air registers 14. The apertures 110a-110d of the flanges 44a-44d align with the apertures 78a-78c of the projections 70, respectively, extending from the housing 16 of the air registers 14.

The arrangement of the projections 70 can guide and assist in the alignment of the actuators 36 in the correct position and orientation through aligning the apertures 78a-78c, 110a-110d. As illustrated in FIG. 7, when the flanges 44a-44dof the actuators 36 are aligned with the apertures 78a-78c of the projections 70, the locating ribs 86 of the projection 70b may extend along side surfaces 114 of the coupling flange 44a to receive fasteners 46 to assist in positioning and securing the actuator 36b onto the bottom wall 24 of the first air register 14a. Accordingly, the position of the locating ribs 86 on the projections 70 may allow for the coupling of the actuators 36 to the housing 16 as the 2-way locator feature and/or as a screw attachment via the fastener 46.

As previously set forth, the housing 16 may be formed from multiple portions, such as a first or top portion and a second or bottom portion. The coupling of the actuators 36 to the housing 16 can assist in securing the first portion of the housing 16 and the second portion of the housing 16, providing additional structural support to the housing 16 and the air registers 14. In such examples, at least one of the projections 70 on the sidewall 26a (which may be formed via the two portions) may extend from the top portion and at least one of the projections 70 may extend from the bottom portion. The actuator 36 is then coupled to each of the portions, which can also assist in maintaining the two portions in position relative to one another.

Additionally, at least one of the flanges 44a-44d may not be used to assist in securing the actuators 36 to the housing 16 (e.g., having at least one flange 44a-44d free of a fastener 46). For example, as illustrated in FIG. 5, coupling flange 44b does not align with any one of the projections 70 to receive fastener 46. For the different coupling locations on the housings 16, a different flange 44a-44d may not receive the fastener 46. The additional flanges 44a-44d may allow for coupling the actuators 36 in different locations on different air registers 14a, 14b using the same actuator 36 configuration. In some implementations, all of the projections 70 may be aligned with any three of the flanges 44a-44d, for example, flanges 44a, 44c, 44d, to receive fasteners 46. Additionally, in some implementations, any one of the flanges 44a-44d may engage with the locating ribs 86 to couple the actuators 36 to the housing 16.

Additionally, the actuators 36 each include a locating flange 118 that extends from the body 38 and is positioned proximate to coupling flange 44a. It is contemplated that the locating flange 118 may be spaced apart from or incorporated with coupling flange 44a, however, it may be further contemplated that the locating flange 118 may be positioned proximate to or incorporated with any one of flanges 44b-44d. The locating flange 118 includes an aperture 122 that may define dowel pin holes or locating bosses to receive the locating pins 90a, 90b to, subsequently, assist in aligning the apertures 110a-110d of the flanges 44a-44d to the projections 70 for coupling of the actuators 36 to the housing 16 of the air registers 14. Accordingly, the locating flange 118 may ensure more precise positioning of the actuators 36 during assembly and proper alignment for engaging the respective vane assemblies 28, 32.

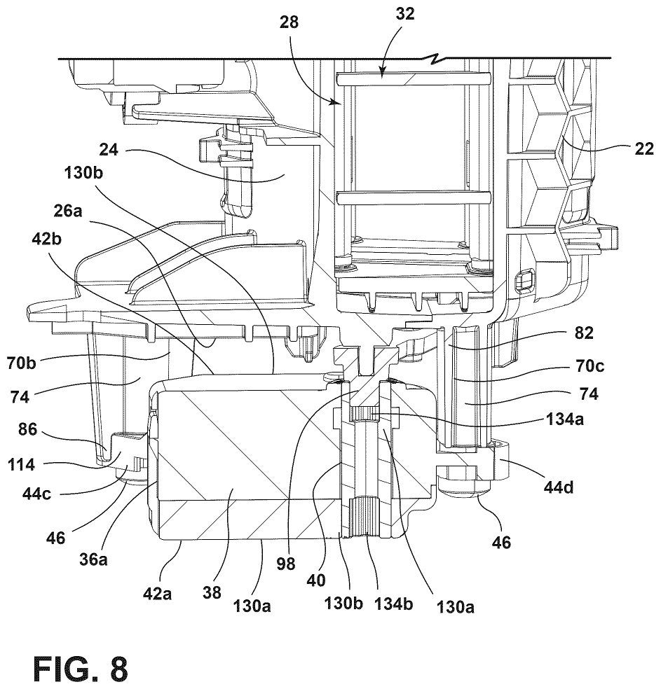

Referring still to FIGS. 6 and 7, as well as FIG. 8, the actuators 36 are arranged in spaces by the respective sets of coupling features (e.g., projections 70, locating pins 90a, 90b) and are configured to engage the respective vane assemblies 28, 32 to drive movement of the vane assemblies 28, 32. The body 38 of the actuators 36 include the first side 42a defining a first surface 130a and the second side 42b defining a second surface 130b. An opening 126 is defined through the body 38 from the first surface 130a of the first side 42a of the body 38 and through the second side 42b and the second surface 130b of the body 38. The coupling joint 40, which engages features for driving the vane assemblies 28, 32, extends through or is disposed within the opening 126 and extends from the first side 42a of the body 38 to the second side 42b of the body 38.

The actuators 36 are each dual-sided engagements to engage the vane assemblies 28, 32 on either side 42a, 42b of the body 38. In this regard, the coupling joint 40 includes a first joint 134a that extends partially through a portion of the opening 126 of the body 38 proximate the first side 42a and a second joint 134b that extends partially through an opposing portion of the opening 126 of the body 38 proximate the second side 42b. In other words, the first joint 134a is positioned in the first portion 136a of the body 38 and engageable at the first surface 130a, and the second joint 134b is positioned in the second portion 136b of the body 38 and engageable at the second surface 130b. For example, either of the first or second joints 134a, 134b of the coupling joint 40 may be operably coupled to the drive link 98 that is coupled to the fastening feature 94 on the first or second sidewalls 26a, 26b of the housing 16 of the air registers 14. As is further described herein, the drive link 98 is positioned between the coupling joint 40 of the actuators 36a, 36c and the housing 16 of the air registers 14 to assist in adjusting the linked vane assembly 28. In another example, either of the first or second joints 134a, 134b of the coupling joint 40 of actuators 36b, 36d may be engaged with the drive peg 104 disposed in the opening 100 of the bottom wall 24 of the air registers 14 to assist in adjusting the pivoting vane assembly 32.

The extension of the coupling joint 40 from the first side 42a to the second side 42b of the body 38 of the actuators 36, as well as the positioning of the flanges 44a-44d and locating flange 118, allows for coupling of either the first side 42a or the second side 42b of the actuators 36 to the housing 16 of the air registers 14. For example, either of the first side 42a or the second side 42b of the actuator 36a may be coupled to the first sidewall 26a of the first air register 14a and either of the first side 42a or second side 42b of the actuator 36c may be coupled to the second sidewall 26b of the second air register 14b. Accordingly, either the first side 42a or the second side 42b of actuators 36b, 36d may be coupled to the bottom wall 24 of the first and second air registers 14a, 14b, respectively. In the illustrated configuration, the first sides 42a of the left side actuators 36a, 36c are adjacent to the housing 16 of the first air register 14a, while the second sides 42b of the right side actuators 36b, 36d are disposed adjacent to the housing 16 of the second air register 14b.

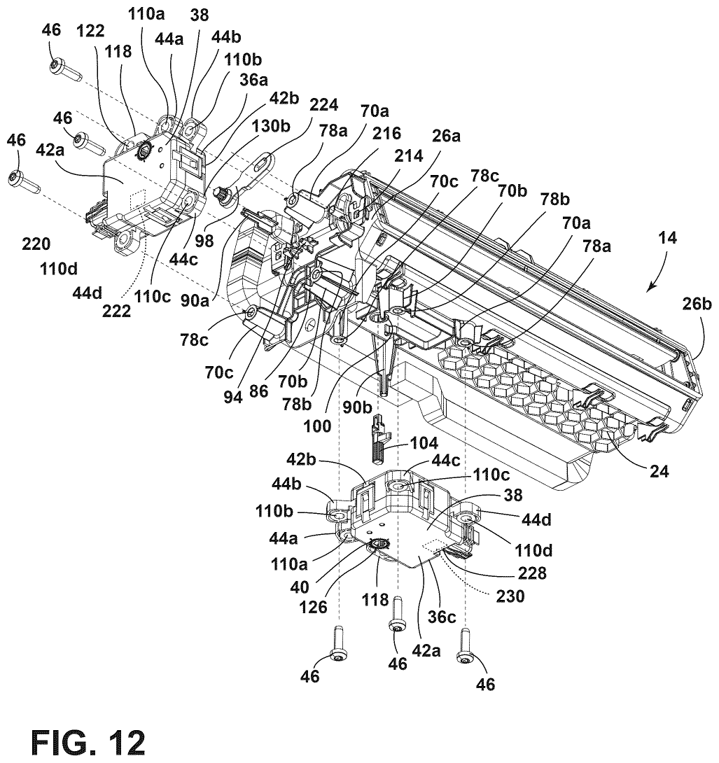

Referring still to FIGS. 7 and 8, as well as FIGS. 3 and 12, during assembly, when coupling either the first or second side 42a, 42b of the actuators 36 to the housing 16, varying components may be used to more efficiently align and position the actuators 36 using multiple actuators 36 having the same configuration. For example, when coupling either the first or second side 42a, 42b of the actuators 36 to the housing 16 of the air registers 14, the locating flange 118 of the actuators 36 and/or the locating ribs 86 defined by the projections 70 of the air registers 14 may be used to assist in locating and positioning the actuators 36 on the housing 16. For example, the aperture 122 of the locating flange 118 of the actuators 36 may receive the locating pins 90a, 90b of the housing 16 to initially position either the first or second side 42a, 42b of the actuators 36 to the first or second sidewalls 26a, 26b or the bottom wall 24 of the housing 16. Subsequently, the flanges 44a-44d of the actuators 36 may then align with the locating ribs 86 of the projections 70 to assist in aligning the apertures 110a-110d of the flanges 44a-44d to the apertures 78a-78c of the projections 70. Once aligned, the apertures 110a-110d of each of the flanges 44a-44d may then receive the fasteners 46 to couple the actuators 36 to the housing 16 of the air registers 14.

Alternatively, at least one of the flanges 44a-44d may be aligned with the locating ribs 86 of the projections 70 to assist in the initial locating and positioning of the apertures 110a-110d of the flanges 44a-44d to the apertures 78a-78c of the projections 70. Subsequently, the locating flange 118 may then be aligned to receive the locating pins 90a, 90b to further assist in positioning the actuators 36 on the housing 16 of the air registers 14. Once the apertures 110a-110d of the flanges 44a-44d are aligned with the apertures 78a-78c of the projections 70, and the locating pins 90a, 90b are disposed within the locating flange 118, the fasteners 46 may be received by the apertures 110a-110d of the flanges 44a-44d to secure the actuators 36 to the housing 16. Accordingly, when the actuators 36 are positioned on the housing 16 via the locating ribs 86 and/or the locating flange 118, the remaining flanges 44a-44d may more easily align with the respective projections 70 of the housing 16. Additionally, when the locating flange 118 or the locating ribs 86 are used to align the actuators 36 to the housing 16, the coupling joint 40 may, consequently, engage with the drive link 98 on the first or second sidewalls 26a, 26b or the drive peg 104 on the bottom wall 24 of the housing 16. As such, the actuators 36 operate as universal actuators 36 that may be utilized on any one of the air registers 14 and in any location on the air registers 14.

Referring now to FIGS. 5-8, the various components (i.e., the flanges 44a-44d, the locating flange 118, the coupling joint 40, the first and second sides 42a, 42b of the body 38) of the actuators 36 provide versatile coupling features that allow for multiple installation configurations of the actuators 36 with the air registers 14. For example, the left linked actuator 36a is operably coupled to the first sidewall 26a of the first air register 14a, and the right linked actuator 36c is operably coupled to the second sidewall 26b of the second air register 14b. Accordingly, the second sidewall 26b of the first air register 14a and the first sidewall 26a of the second air register 14b do not include an actuator. Further, the left pivot actuator 36b is operably coupled to the bottom wall 24 of the first air register 14a and the right pivot actuator 36d is operably coupled to the bottom wall 24 of the second air register 14b. Additionally, during manufacturing, the first or second side 42a, 42b of the actuators 36 may be coupled to either of the first or second sidewalls 26a, 26b and the bottom wall 24. Accordingly, the versatility of the actuators 36 enables optimal positioning of the actuators 36 relative to the linked and pivoting vane assemblies 32 and the housing 16 of the air registers 14, enhancing the overall efficiency and effectiveness of an airflow control mechanism of the air delivery system 10 and the manufacturing process thereof. In addition, the versatility of the coupling of the actuators 36 to the housing 16 provides for additional structural support of the first and second portion of the housing 16 further securing the air registers 14 in the vehicle 12.

The air delivery system 10 of the vehicle 12 may include a third air register 14a and a fourth air register 14b disposed on the dashboard 58 that may generally direct air towards a passenger seat 56 of the vehicle 12, as opposed to the first and second air registers 14a, 14b which may generally direct air towards a driver seat 56 of the vehicle 12. The third and fourth actuators 14a, 14b may be positioned proximate the first and second air registers 14a, 14b. The third and fourth air registers 14a, 14b are substantially identical to the first and second air registers 14a, 14b, including the positioning of actuators 36 that may be coupled to a housing 16 of the third and fourth air registers 14a, 14b to adjust a linked vane assembly 28 and a pivoting vane assembly 32. For example, an actuator 36a may be coupled to a first sidewall 26a of the third air register 14a and another actuator 36c may be coupled to a second sidewall 26b of the fourth air register 14b in a similar manner as discussed herein. Accordingly, the second sidewall 26b of the third air register 14a and the first sidewall 26a of the fourth air register 14b do not include actuators 36. Additionally, actuators 36b, 36d may be coupled to a bottom wall 24 of the third and fourth air registers 14a, 14b. Therefore, the first and second air registers 14a, 14b may generally mirror and/or may be substantially similar to the third and fourth air registers 14a, 14b.

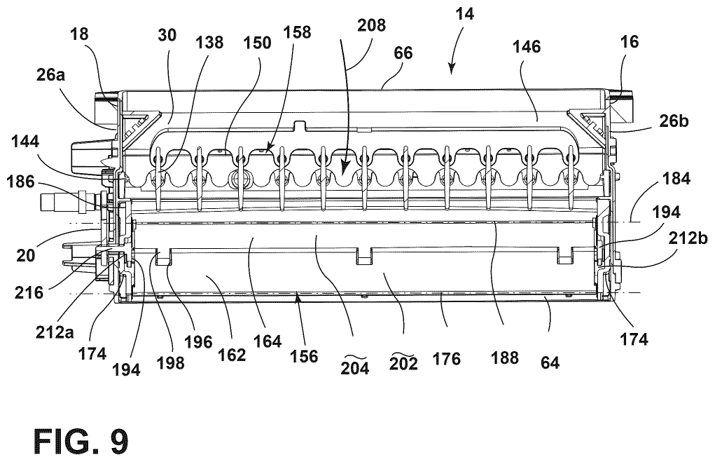

Referring now to FIGS. 9-11, the actuators 36 control the airflow control features of the air delivery system 10, which includes the pivoting vane assembly 32 and the linked vane assembly 28. The pivoting vane assembly 32 and the linked vane assembly 28 provide for adjusting airflow in a horizontal direction and a vertical direction, respectively. To adjust the airflow in the horizontal direction, the air registers 14 include the pivoting vane assembly 32 with vanes 138. The vanes 138 are configured as pivoting, vertical vanes 138 disposed within the upstream housing portion 18. The vanes 138 generally extend between an upper bracket 140 coupled to an upper interior surface 142 of the housing 16 and a lower bracket 144 coupled to a lower interior surface 146 of the housing 16. The vanes 138 each pivot or rotate about a respective rotational axis 148, which are generally vertical axes. Each of the vanes 138 is coupled to a link bar 150, which allows the vanes 138 to be rotated simultaneously. As the vanes 138 are rotated, the vanes 138 deflect air traveling through the air registers 14 to adjust the airflow horizontally.

The downstream housing portion 20 has a greater height than the upstream housing portion 18 to accommodate the movement of the linked vane assembly 28, as described further herein. The upper and lower interior surfaces in the downstream housing portion 20 are generally curved or “V” shaped. An opening of each “V” faces toward the opposing side of the downstream housing portion 20, creating a greater height within the downstream housing portion 20.

Referring still to FIGS. 9-11, the linked vane assembly 28 includes a first linked vane 154, which is generally an upper horizontal vane, and a second linked vane 156, which is generally a lower horizontal vane. Each of the first and second linked vanes 154, 156 extends from the outlet 64 to the upstream housing portion 18. The first and second linked vanes 154, 156 are generally horizontal vanes that direct air in the vertical direction. Accordingly, the linked vane assembly 28 directs the air in a direction perpendicular to the pivoting vane assembly 32.

The first linked vane 154 includes a first driver portion 158 positioned downstream of a first follower portion 160. Similarly, the second linked vane 156 includes a second driver portion 162 positioned downstream of a second follower portion 164. The first and second driver portions 158, 162 are coupled to the housing 16 proximate to the outlet 64, and the first and second follower portions 160, 164 are coupled to the housing 16 proximate to the first cavity portion 30. The housing 16 defines downstream apertures 166a, 166b on each of the first sidewall 26a and the second opposing sidewall 26b thereof. The downstream apertures 166a, 166b are disposed proximate to the outlet 64 at different heights for engagement with the first and second linked vanes 154, 156, respectively.

The first driver portion 158 includes pins 170 that extend through downstream apertures 166a. This engagement allows the first driver portion 158 to rotate about a rotational axis 172. The second driver portion 162 includes pins 174 that extend through the downstream apertures 166b, which allows the second driver portion 162 to rotate about a rotational axis 176.

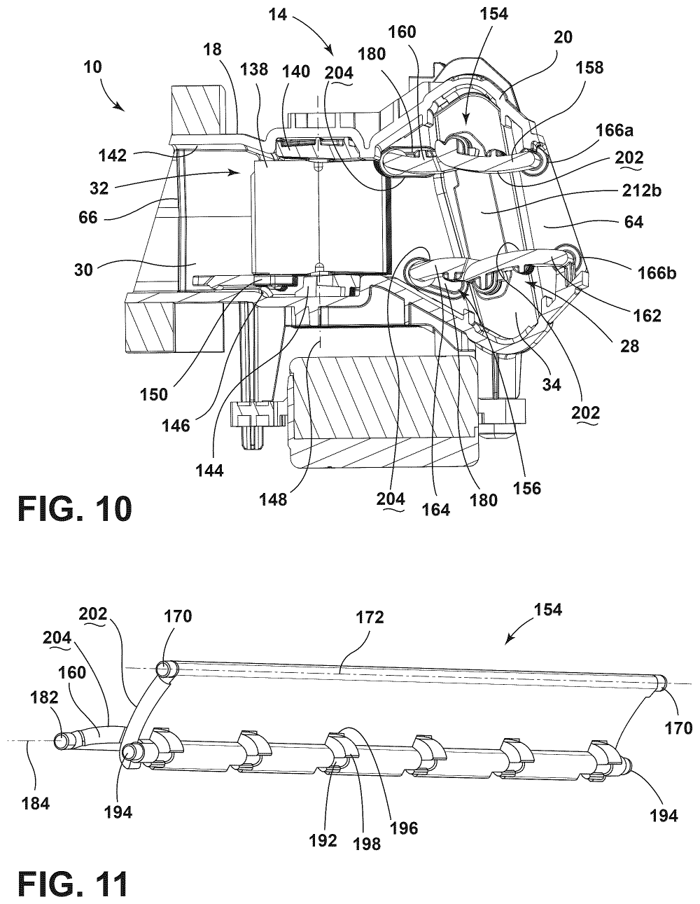

The rotational axes 172, 176 are generally horizontal axes and may extend parallel to one another. The housing 16 also defines upstream slots 180 on each of the first and second sidewalls 26a, 26b thereof. The upstream slots 180 accommodate both rotational and sliding movement of the follower portions 160, 164, respectively. The upstream slots 180 may extend at different angles within the housing 16, as illustrated in FIG. 10, based on the movement of the follower portions 160, 164. Alternatively, the upstream slots 180 may extend at the same angle without departing the teachings herein. The length of the upstream slots 180 may depend on the sliding movement of the follower portions 160, 164.

The first follower portion 160 includes pins 182 that engage the upstream slots 180. The first follower portion 160 rotates about a rotational axis 184 and slides within the upstream slots 180. The second follower portion 164 includes pins 186 that engage the upstream slots 180. The second follower portion 164 rotates about a rotational axis 188 and slides within the upstream slots 180. Accordingly, each of the follower portions 160, 164 rotates and slides relative to the housing 16 to allow the linked vanes 154, 156 to form the selected shape to direct the airflow vertically.

Referring still to FIGS. 9-11, the first follower portion 160 is rotatably coupled to the first driver portion 158, and the second follower portion 164 is rotatably coupled to the second driver portion 162. The first linked vane 154 is illustrated in FIG. 11 and will be described in detail herein. The second linked vane 156, illustrated in FIG. 10, is generally constructed and functions the same as the first linked vane 154. Each of the first driver portion 158 and the first follower portion 160 include pins 170, 182 for rotatably engaging the housing 16. The pins 170, 182 are on distal ends of the first driver portion 158 and the first follower portion 160, respectively. Proximal ends of the first driver portion 158 and the first follower portion 160 are rotatably coupled to one another.

The first driver portion 158 has coupling bars 192 on the proximal end and drive pins 194 extending from each side of the first driver portion 158 on the proximal end. Additionally, the first driver portion 158 defines a receiving aperture 196 proximate to each coupling bar 192. The first follower portion 160 includes coupling features 198 that extend through the receiving apertures 196 and couple to the coupling bars 192. In certain aspects, the coupling features 198 snap engage the coupling bars 192. The coupling features 198 are configured to rotate about the coupling bars 192, providing a hinged engagement. Movement of the driver portion 158 causes complimentary movement of the follower portion 160 through the hinged engagement.

Each of the first driver portion 158, the first follower portion 160, the second driver portion 162, and the second follower portion 164 defines an arcuate shape. The driver portions 158, 162 have curved guide surfaces 202 oriented toward one another, and the follower portions 160, 164 have curved guide surfaces 204 oriented toward one another. The first linked vane 154 and the second linked vane 156 are arranged on upper and lower sides of an airflow path 208 extending through the air registers 14. The curved guide surfaces 202, 204 operate to guide the airflow path 208 in the vertical direction with the movement of the linked vane assembly 28.

Referring still to FIGS. 9-11, as well as FIG. 12, the first linked vane 154 and the second linked vane 156 are each coupled to link features 212a, 212b. In certain aspects, the driver portions 158, 162 are coupled to the link features 212a, 212b. In this way, the first linked vane 154 is coupled to the second linked vane 156 via the link features 212a, 212b, allowing for simultaneous or concurrent movement of the linked vanes 154, 156. The link feature 212a is disposed proximate to the first sidewall 26a of the housing 16 of the first register 14a and proximate to the second sidewall 26b in the second register 14b and coupled to a first or outer side of the linked vanes 154, 156. The link feature 212b is disposed proximate to the opposing sidewall 26a, 26b, such as the second sidewall 26b in the first register 14a and the first sidewall 26a in the second register 14b, and is coupled to a second or inner side of the linked vanes 154, 156. The link features 212a, 212b are configured to adjust vertically within the housing 16 of the air registers 14. The link features 212a, 212b allow the linked vanes 154, 156 to be adjusted simultaneously. The use of two link features 212a, 212b arranged on opposing sides of the linked vanes 154, 156 minimizes or prevents twisting or binding as the linked vanes 154, 156 are moved. The drive pins 194 on each of the driver portions 158, 162 are coupled to the link features 212a, 212b. In this way, the linked vanes 154, 156 are coupled to the link features 212a, 212b proximate to the hinged engagement.

The first sidewall 26a of the housing 16 of the first air register 14a and the second sidewall 26b of the housing 16 of the second air register 14b define slots 214. In each air register 14, the link feature 212a includes an engagement pin 216 that extends through the slot 214 to operably engage the actuators 36a, 36c via the drive link features 98. While the air registers 14 include two link features 212a, 212b, the link feature 212a may engage the actuators 36 while the link feature 212b does not. The actuators 36 operably engage the engagement pin 216 to adjust the engagement pin 216 along the slot 214 vertically adjusting the link feature 212a, which consequently causes movement of the driver portions 158, 162 from a single side of the air registers 14. The movement of the driver portions 158, 162 causes movement of the follower portions 160, 164 through the hinged engagement between the driver portions 158, 162 and the follower portions 160, 164. Further, the linked vanes 154, 156 are driven from a location proximate to the hinged engagement.

Referring still to FIGS. 9-12, the drive link 98 may be coupled to the fastening feature 94 of the housing 16 of the first or second sidewalls 26a, 26b of the air registers 14. The drive link 98 may rotate about a rotational axis defined by the fastening feature 94. Further, the fastening feature 94 may provide guidance and stability for the movement of the drive link 98. The first or second joints 134a, 134b of the coupling joint 40 (i.e., the first joint 134a for the first register 14a and the second joint 134b for the second register 14b) engage with the drive links 98 to assist in operably coupling the link features 212a with the actuators 36a, 36c. Accordingly, the drive links 98 extend between the actuators 36a, 36c and the engagement pin 216 of the link feature 212a. The drive link 98 may engage with the engagement pin 216 via a link slot 224 of the drive link 98.

The link actuators 36a, 36c can each include a motor 220 having or operably coupled with a position sensor 222. When the motor 220 is activated, the motor 220, via the coupling joint 40, causes the drive links 98 to adjust (e.g., rotate) and movement of the drive links 98, consequently, adjusting the position of the engagement pin 216 relative to the slot 214, causing movement of the linked vanes 154, 156. The position sensor 222 monitors the position of the linked vanes 154, 156, and allows the linked vane assembly 28 to be adjusted to the selected position to provide the selected vertical direction of the airflow path 208.

The air registers 14 also generally include the left pivot actuator 36b and the right pivot actuator 36d that engage the pivoting vane assembly 32. The left and right pivot actuators 36b, 36d also include a motor 228 operably coupled to at least one of the vanes 138 and the link bar 150. The motor 228 also includes or is operably coupled with a position sensor 230 to be able to adjust the vanes 138 to a selected position, thereby providing the selected horizontal direction of the airflow path 208. Additionally, the drive peg 104 generally extends from one of the vanes 138 of the pivoting vane assembly 32 along a respective rotational axis 148 through the opening 100 to engage the coupling joint 40. When the motor 228 is activated, the drive peg 104 may rotate about the rotational axis 148 to adjust the one of the vanes 138, which, consequently, adjusts the remainder of the vanes 138 via the link bar 150. Each of the pivoting vane assembly 32 and the linked vane assembly 28 may automatically be adjusted to direct the airflow path 208 both horizontally and vertically.

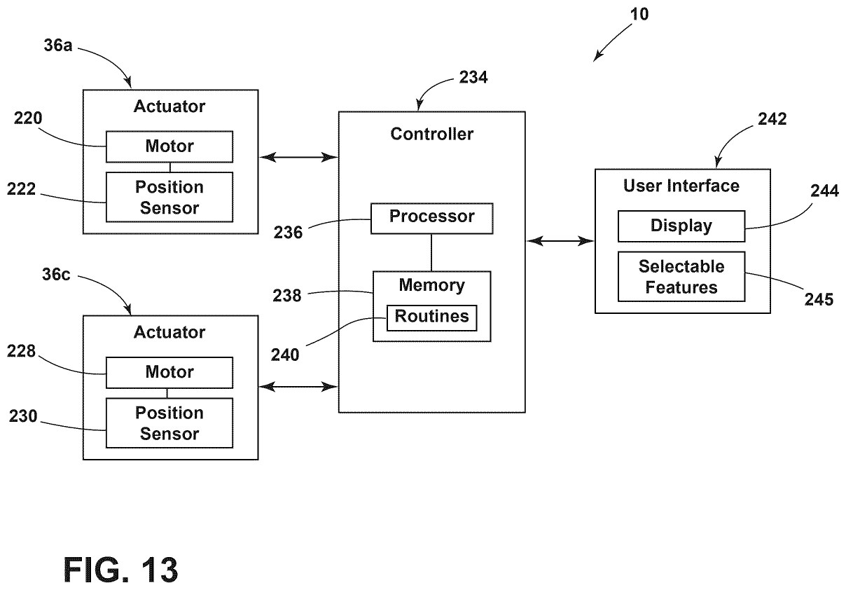

Referring to FIG. 13, the air delivery system 10 includes a controller 234 that has a processor 236, a memory 238, and other control circuitry. Instructions or routines 240 are stored in the memory 238 and executable by the processor 236. The controller 234 is in communication with a user interface 242, which may include a display 244 or other selectable feature 245 (e.g., buttons, switches, knobs, etc.), such as those on a center stack 246 in the vehicle 12. The passenger or user may input a selection into the user interface 242 regarding the horizontal and vertical direction of the airflow expelled from the air registers 14. The input is communicated to the controller 234, which may then activate one or both of the motors 220, 228.

The controller 234 may include at least one routine 240 to determine the current position of the pivoting vane assembly 32 and the linked vane assembly 28 from the position sensors 222, 230. If the current position does not match the position for the selected airflow path 208, the controller 234 adjusts the linked vane assembly 28 or the pivoting vane assembly 32 via the actuators 36. The controller 234 may continue to monitor the position of the pivoting vane assembly 32 and the linked vane assembly 28 until the position corresponds with the selected airflow path 208. The controller 234 may store position information that correlates the position of the pivoting vane assembly 32 with horizontal directions and the linked vane assembly 28 with vertical directions.

Referring to FIGS. 1-13, in operation, the air registers 14 receive conditioned air from the HVAC assembly via the ducting. The air travels through the inlet 66 and through the first cavity portion 30. The air is then deflected horizontally by the vanes 138 of the pivoting vane assembly 32. After being deflected horizontally, the air travels into the second cavity portion 34. The air follows the curved guide surfaces 202, 204 and is guided vertically based on the position of the linked vane assembly 28. The air is then expelled through the outlet 64. Depending on the vertical orientation of the airflow path 208 exiting the air registers 14, the air follows the curved surfaces of the bezel 60. The air is directed to the selected horizontal and vertical direction and into the interior compartment 54. Based on the positions of the pivoting vane assembly 32 and the linked vane assembly 28, the air may exit the air registers 14 at a different vertical and/or horizontal angle relative to an entry direction at the inlet 66.

Use of the present device and system may provide for a variety of advantages. For example, the housing 16 of the air registers 14 includes the projections 70 defining the locating ribs 86 to assist in aligning and positioning the actuators 36 to the air registers 14. Similarly, the actuators 36 include the locating flanges 118, which may receive the locating pins 90a, 90b disposed on the air registers 14 to further assist in positioning and securing the actuators 36 to the air registers 14. Additionally, the locating ribs 86 on the projections 70 of the housing 16 further assist in aligning and positioning the actuators 36 to the housing 16 of the air registers 14. Additionally, the actuators 36 include the coupling joint 40 that extends from the first side 42a of the actuators 36 to the second side 42b of the actuators 36 defining the first joint 134a and the second joint 134b. The coupling joint 40 further secures the actuators 36 to the air registers 14 and provides for the operation of the drive link 98 and the drive peg 104 disposed on the first or second sidewalls 26a, 26b and the bottom wall 24 of the housing 16, respectively.

The versatility of the actuators 36, including the ability to utilize the first and second side 42b of the actuators 36 to couple the actuators 36 to the housing 16 of the air registers 14 allows the actuators 36 to be positioned on varying air registers 14 providing a universal actuator 36 that may be utilized in a multitude of positions along the housing 16. Accordingly, the actuators 36 may be adjusted or flipped to connect with the kinematic input of the air registers 14. Additionally, in some implementations, three of the flanges 44a-44d may be used to couple the actuators 36 to the housing 16, however, all flanges 44a-44d may be used. The coupling flanges 44a-44d that may not be used may act as an additional screw attachment to assist in coupling the actuators 36 in different configurations along the housing 16 of the air registers 14. Moreover, the housing may provide both a four-way locator (e.g., the locating pins 90a, 90b) and a two-way locator (e.g., the locating ribs 86) for each actuator 36. Additionally, the dual coupling joint 40 having the first joint 134a and the second joint 134b allows for coupling of the linked and pivoting vane assemblies 28, 32 to assist in adjusting the airflow path 208 of the air registers 14. Additional benefits or advantages may be realized and/or achieved.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An air delivery system for a vehicle, comprising:
at least one air register assembly including:
a housing defining a first portion and a second portion, wherein the housing includes a top wall, a bottom wall, and first and second sidewalls;
a linked vane assembly is disposed in a cavity defined by the first portion of the housing; and
a pivoting vane assembly is disposed in a cavity defined by the second portion of the housing;
a first actuator operably coupled with the linked vane assembly to direct movement of the linked vane assembly, wherein the first actuator is coupled with the first sidewall; and
a second actuator operably coupled with the pivoting vane assembly to direct movement of the pivoting vane assembly, wherein the second actuator is coupled with the bottom wall, and wherein each of the first and second actuators includes:
a body including a first side and a second side, wherein the body defines a coupling joint in the first side and the second side; and
coupling flanges extending from the body to receive fasteners for coupling the respective actuator to the housing.

2. The air delivery system of claim 1, wherein each flange defines an aperture for coupling the first and second actuators to the housing via the fasteners, and wherein the coupling flanges extend in different directions from the body of the respective of the first actuator and the second actuator.

3. The air delivery system of claim 1, wherein the at least one air register assembly includes a plurality of projections extending from each of the first sidewall and the bottom wall of the housing, and wherein at least one of the plurality of projections on each of the first sidewall and the bottom wall includes locating ribs.

4. The air delivery system of claim 3, wherein at least one of the coupling flanges of the first actuator is disposed between the locating ribs on the first sidewall, and wherein at least one of the coupling flanges of the second actuator is disposed between the locating ribs on the bottom wall.

5. The air delivery system of claim 1, wherein the body of each of the first and second actuators includes a locating flange, and wherein the housing includes a locating pin extending from each of the first sidewall and the bottom wall.

6. The air delivery system of claim 5, wherein each of the locating flanges defines an aperture, and wherein the locating flange of the first actuator is configured to receive the locating pin extending from the first sidewall and the locating flange of the second actuator is configured to receive the locating pin extending from the bottom wall of the housing.

7. The air delivery system of claim 1, further comprising:
third and fourth actuators, wherein the at least one air register assembly includes a first air register and a second air register, and wherein the first and second actuators are coupled with the first air register, and further wherein the third actuator is coupled to the second sidewall of the housing of the second air register and the fourth actuator is coupled to the bottom wall of the housing of the second air register.

8. The air delivery system of claim 7, wherein the first side of the first and second actuators engage the housing of the first air register to allow the coupling joints on the first sides of the first and second actuators to engage the linked vane assembly and the pivoting vane assembly, respectively, of the first air register, and wherein the second side of the third and fourth actuators engage the housing of the second air register to allow the coupling joints on the second sides of the third and fourth actuators to engage the linked vane assembly and the pivoting vane assembly, respectively, of the second air register.

9. The air delivery system of claim 1, further comprising:
a link feature including an engagement pin extending through a slot defined by the first sidewall, wherein the link feature is coupled with the linked vane assembly;
a drive link operably coupled to the coupling joint of the first side of the first actuator and the link feature to adjust a position of the linked vane assembly; and
a drive peg operably coupled to the coupling joint of the first side of the second actuator and the pivoting vane assembly to adjust a position of the pivoting vane assembly.

10. The air delivery system of claim 9, wherein the bottom wall of the housing defines an opening, and wherein the drive peg extends through the opening to engage the coupling joint of the second actuator.

11. An air register assembly for a vehicle, comprising:
an air register including:
a housing having a top wall, a bottom wall, and first and second sidewalls to at least partially define a cavity;
coupling projections extending from the housings, wherein at least one of the coupling projections defines locating ribs;
locating pins extending from the housing proximate to the coupling projections;
a first vane assembly having first vanes disposed in the cavity; and
a second vane assembly having second vanes disposed in the cavity, wherein the second vane assembly is positioned proximate the first vane assembly; and
a first actuator operably coupled to the first sidewall of the air register via the coupling projections and at least one of the locating pins, wherein the first actuator engages the first vane assembly to direct movement of the first vanes in a first direction; and
a second actuator operably coupled to the bottom wall of the air register via the coupling projections and at least one of the locating pins, wherein the second actuator engages the second vane assembly to direct movement of the second vanes in a second direction.

12. The air register assembly of claim 11, wherein each of the first actuator and the second actuator includes a body positioned within a space defined by a respective set of the coupling projections, and wherein the body of the first and second actuators includes a first side and a second side, the first side opposite the second side.

13. The air register assembly of claim 12, wherein each of the first actuator and the second actuator includes a coupling joint having a first joint extending partially through a first portion of the body from the first side and a second joint extending partially through a second portion of the body from the second side.

14. The air register assembly of claim 13, wherein the coupling projections and the locating pins each extend from the first sidewall and the bottom wall of the housing, and wherein the first side of the first actuator is disposed adjacent to the first sidewall and the first joint is operably engaged with the first vanes of the first vane assembly, and wherein the first side of the second actuator is disposed adjacent to the bottom wall and the second joint is operably engaged with the second vanes of the second vane assembly.

15. The air register assembly of claim 13, wherein the coupling projections and the locating pins each extend from the second sidewall and the bottom wall of the housing wherein the second side of the first actuator is disposed adjacent to the second sidewall and the second joint is operably engaged with the first vanes of the first vane assembly, and wherein the second side of the second actuator is disposed adjacent to the bottom wall and the second joint engages the second vanes of the second vane assembly.

16. The air register assembly of claim 11, further comprising:
a second air register including a housing having a first sidewall, a second sidewall, and a bottom wall at least partially defining a cavity;
a third actuator operably coupled to the second sidewall of the housing of the second air register; and
a fourth actuator operably coupled to the bottom wall of the housing of the second air register.

17. An air register assembly for a vehicle, comprising:
a housing including a bottom wall and opposing sidewalls to at least partially define a cavity;
a fastening feature extending from at least one of the opposing sidewalls of the housing;
a vane assembly disposed in the cavity of the housing, wherein the vane assembly includes first vanes and second vanes configured to direct air to an interior of said vehicle;
actuators operably coupled to the housing, wherein the actuators are configured to adjust the first vanes and the second vanes, respectively, and wherein the actuators each include a coupling joint;
a drive link operably coupled to the fastening feature and the coupling joint of one of the actuators; and
a link feature disposed within the cavity and including an engagement pin extending through a slot on the housing, wherein the link feature is coupled to the drive link and the vane assembly, and wherein the one of the actuators rotates the drive link to move the link feature in a predetermined path along the slot to adjust the position of the first vanes.

18. The air register assembly of claim 17, further comprising:
an opening defined on the bottom wall of the housing; and
a drive peg disposed partially within the opening of the housing, wherein the drive peg is coupled to the second vanes of the vane assembly.

19. The air register assembly of claim 18, wherein the drive peg engages the coupling joint of a second one of the actuators to rotate the drive peg and adjust the position of the second vanes.

20. The air register assembly of claim 17, wherein each of the actuators includes a first side and a second side, and wherein the coupling joint is defined on each of the first side and the second side such that each of the first side and the second side of each of the actuators are configured to engage the vane assembly.
